(19) United States
(12) Patent Application Publication
(10) Pub. No.: US 2013/0080689 A1
(43) Pub. Date: Mar. 28, 2013

(54) DATA STORAGE DEVICE AND RELATED DATA MANAGEMENT METHOD

(71) Applicants: HAN-CHAN JO, YONGIN-SI (KR); JINHYUK KIM, HWASEONG-SI (KR); DONGHYUN SONG, HWASEONG-SI (KR)

(72) Inventors: HAN-CHAN JO, YONGIN-SI (KR); JINHYUK KIM, HWASEONG-SI (KR); DONGHYUN SONG, HWASEONG-SI (KR)

(73) Assignee: SAMSUNG ELECTRONICS CO., LTD., SUWON-SI (KR)

(21) Appl. No.: 13/604,710

(22) Filed: Sep. 6, 2012

(30) Foreign Application Priority Data
Sep. 22, 2011 (KR) 10-2011-0095889

(51) Int. Cl. G06F 12/02

(52) U.S. Cl. 711/103; 711/E12.008

(57) ABSTRACT

A storage device performs data management for a nonvolatile memory device by detecting an allocation order of a first memory block, assigning page data of the first memory block to a second memory block or a third memory block having different erase counts based on the allocation order.

### CROSS-REFERENCE TO RELATED APPLICATIONS

This application claims priority under 35 U.S.C §119 to Korean Patent Application No. 10-2011-0095889 filed Sep. 22, 2011, the subject matter of which is hereby incorporated by reference.

### BACKGROUND OF THE INVENTION

The inventive concept relates generally to electronic memory technologies. More particularly, the inventive concept relates to storage devices and methods of operating storage devices to improve wear-leveling and data compaction efficiency.

Semiconductor memory devices can be roughly divided into two categories according to whether they retain stored data when disconnected from power. These categories include volatile memory devices, which lose stored data when disconnected from power, and nonvolatile memory devices, which retain stored data when disconnected from power. Examples of volatile memory devices include dynamic random access memory (DRAM) and static random access memory (SRAM), and examples of nonvolatile memory devices include read only memory (ROM), magnetoresistive random access memory (MRAM), resistive random access memory (RRAM), and flash memory.

Flash memory is an especially popular form of nonvolatile memory due to attractive features such as relatively high storage density, efficient performance, low cost per bit, and an ability to withstand physical shock. Nevertheless, a well-known shortcoming of flash memory and certain other forms of nonvolatile memory is limited program and/or erase endurance, which refers to a limited number of times that memory cells can be programmed and/or erased before they fail.

In an effort to reduce failures that may be caused by limited program and/or erase endurance, researchers have developed wear-leveling and data compaction techniques, which attempt to equalize the number of program and/or erase operations performed on different memory cells. These techniques, however, can hinder the performance of flash memory and other forms of nonvolatile memory, so researchers are engaged in continuing efforts to develop improved methods of addressing problems associated with limited program and/or erase endurance.

### SUMMARY OF THE INVENTION

In an embodiment of the inventive concept, a method is provided for operating a storage device comprising a nonvolatile memory device. The method comprises detecting an allocation order of a first memory block storing page data, and assigning page data in the first memory block to a second memory block having a first erase count or a third memory block having a second erase count larger than the second erase count, based on the detected allocation order.

In another embodiment of the inventive concept, a data storage device is provided. The data storage comprises a nonvolatile memory device and a memory controller configured to assign page data in a first memory block to a second memory block or a third memory block having an erase count larger than the second memory block based on an allocation order of the first memory block assigned to write data.

In another embodiment of the inventive concept, a method of managing data in a nonvolatile memory device comprises determining an allocation order of a first memory block, comparing the allocation order to a reference value, and assigning valid data of the first memory block to a hot block or a cold block according to a result of the comparison.

### BRIEF DESCRIPTION OF THE DRAWINGS

The drawings illustrate selected embodiments of the inventive concept. In the drawings, like reference numbers indicate like features.

FIG. 1 is a diagram illustrating software layers of an electronic device according to an embodiment of the inventive concept.

FIG. 2 is a block diagram illustrating an electronic device according to an embodiment of the inventive concept.

FIG. 3 is a block diagram illustrating a nonvolatile memory device in FIG. 2 according to an embodiment of the inventive concept.

FIG. 4 is a diagram for describing a data compaction operation according to an embodiment of the inventive concept.

FIG. 5 is a diagram for describing a data management method according to an embodiment of the inventive concept.

FIG. 6 is a flowchart illustrating a data management method according to an embodiment of the inventive concept.

FIG. 7 is a flowchart for describing a page allocation method of FIG. 6 according to an embodiment of the inventive concept.

FIG. 8 is a block diagram illustrating an electronic device comprising a solid state disk according to an embodiment of the inventive concept.

FIG. 9 is a block diagram illustrating a memory system according to an embodiment of the inventive concept.

FIG. 10 is a block diagram illustrating a data storage device according to an embodiment of the inventive concept.

FIG. 11 is a diagram illustrating a computing system comprising a flash memory device according to an embodiment of the inventive concept.

### DETAILED DESCRIPTION

Embodiments of the inventive concept are described below with reference to the accompanying drawings. These embodiments are presented as teaching examples and should not be construed to limit the scope of the inventive concept.

In the description that follows, the terms first, second, third, etc., may be used to describe various features. The described features, however, are not to be limited by these terms. Rather, these terms are used merely to distinguish between different features. Accordingly, a first feature could be termed a second feature and vice versa without changing the meaning of the relevant description.

The terminology used herein is for the purpose of describing particular embodiments only and is not intended to limit the inventive concept. The singular forms “a”, “an” and “the” are intended to encompass the plural forms as well, unless the context clearly indicates otherwise. The terms “comprises” and/or “comprising,” when used in this specification, indicate the presence of stated features but do not preclude the presence or addition of one or more other features. The term “and/or” indicates any and all combinations of one or more of the associated listed items.

Where a feature is referred to as being “on” or “connected to” another feature, it can be directly on or connected to the other feature, or intervening features may be present. In contrast, where a feature is referred to as being “directly on” or “directly connected to” another feature, there are no intervening features present.

Unless otherwise defined, all terms (including technical and scientific terms) used herein have the same meaning as commonly understood by one of ordinary skill in the art. Terms such as those defined in commonly used dictionaries should be interpreted as having a meaning that is consistent with their meaning in the context of the relevant art and/or the present specification and will not be interpreted in an idealized or overly formal sense unless expressly so defined herein.

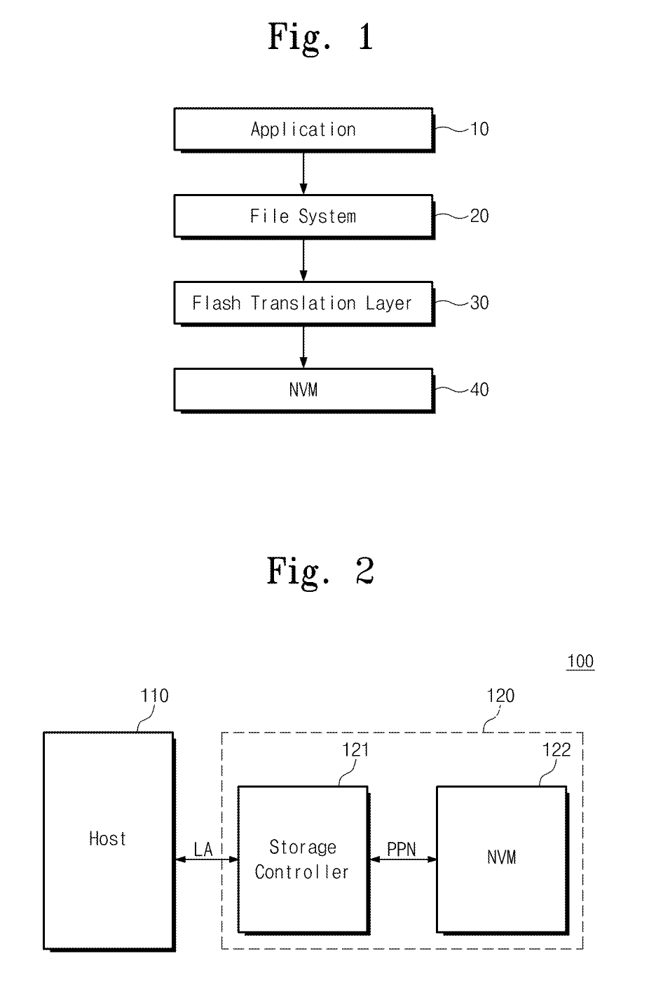

FIG. 1 is a diagram illustrating software layers of an electronic device according to an embodiment of the inventive concept.

Referring to FIG. 1, the software layers comprise an application 10, a file system 20, and a Flash Translation Layer (FTL) 30. These software layers are implemented logically above a hardware layer comprising a nonvolatile memory 40.

Among the software layers, the uppermost application and file system layers can be implemented or operated within an operating system (OS). File system 20 can be defined by a set of virtual database structures for hierarchically storing, searching, accessing, and operating the database.

FTL 30 provides an interface to hide certain details of nonvolatile memory 40, such as the precise physical locations of erase operations. For instance, in a write operation of nonvolatile memory 40, FTL 30 may map a logical address LA generated by file system 20 onto a physical address PA of nonvolatile memory 40. This mapping effectively hides physical address PA from file system 20, and it allows physical address PA to be changed in a way that is transparent to file system 20. The effective hiding of certain details through the use of FTL 30 allows nonvolatile memory 40 to efficiently reorganize stored data according to the requirements of wear-leveling, data compaction, and other operations.

FTL 30 maps logical address LA of file system 20 onto a logical page address LPN based on a page mapping technique. Logical page address LPN is then mapped onto a physical page address PPN. FTL 30 assigns page data to memory blocks having different erase counts according to an update frequency of the page data. For instance, pages being frequently updated may be managed in the same memory block.

FTL 30 may use the page mapping technique to improve overall write performance of a system incorporating nonvolatile memory device 40. As an example, nonvolatile memory device 40 may comprise a NAND flash memory device in a server, and the page mapping technique may be used to improve write performance for frequently updated server data such as metadata. Moreover, FTL may also improve the performance of a system comprising a NAND flash memory device through the use of flexible and efficient data compaction techniques (e.g., garbage collection or merge operations).

To manage data compaction and wear-leveling efficiently in a storage device comprising a nonvolatile memory device, page mapping may be performed according to attributes of memory blocks. For example, each memory block may be categorized as a hot block or a cold block, where a hot block is a block having high update frequency and a cold block is a block having low update frequency. Page data in hot blocks may be collectively assigned to a memory block having a relatively low erase count. On the other hand, page data in cold blocks may be collectively assigned to a memory block having a relatively high erase count. These assignments can be made by FTL 30.

The probability that page data in a hot block has a high update frequency may be large. That is, the probability that such page data is copied into another block upon data compaction may be high. On the other hand, the probability that page data in a cold block is copied into another block upon data compaction may be low. Accordingly, wear-leveling may be efficiently managed overall by assigning page data with a high probability of data compaction to a memory block having a low erase count.

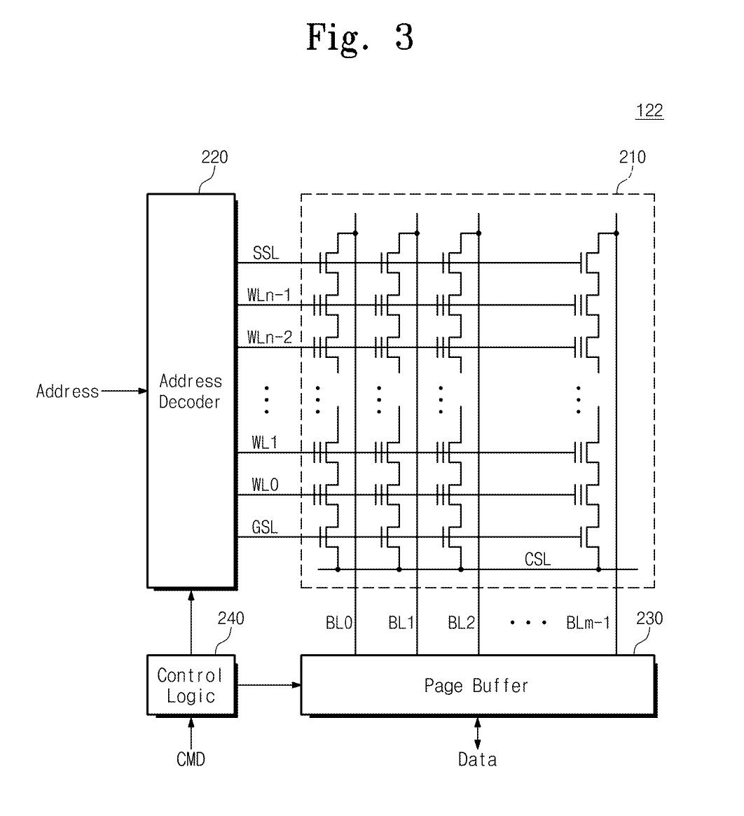

FIG. 2 is a block diagram illustrating an electronic device according to an embodiment of the inventive concept.

Referring to FIG. 2, an electronic device 100 comprises a host 110 and a storage device 120. Storage device 120 comprises a storage controller 121 and a nonvolatile memory device 122.

Upon issuance of a write request, host 110 sends write data and a logical address LA to storage device 120. Where electronic device 100 is a personal computer or a notebook, logical address LA may be provided by sector. For example, in response to a write request, host 110 may provide storage device 120 with a start address LBA and a sector countnSC for writing data.

Storage device 120 stores write data provided from host 110. For this operation, storage controller 121 interfaces with host 110 and nonvolatile memory device 122. Storage controller 121 controls nonvolatile memory device 122 in response to a write command of host 110 to write data provided from host 110. Storage controller 121 controls a read operation of nonvolatile memory device 122 in response to a read command from host 110.

Storage controller 121 typically comprises software such as an FTL. The FTL can perform operations such as those described above in relation to FTL 30 of FIG. 1. For example, in a write operation of nonvolatile memory device 122, the FTL maps a logical address LA generated by the file system onto a physical address PPN of nonvolatile memory device 122.

The FTL, which is generally driven by storage controller 121, maps addresses according to a page mapping technique. The FTL maps a logical address (e.g., a sector address) provided from host 110 onto a page address PPN, which is a physical address of nonvolatile memory device 122. The FTL assigns page data to different memory blocks according to attributes of the memory blocks. For example, the FTL may assign page data in a hot block to a memory block having a low erase count, or it may assign page data in a cold block to a memory block having a high erase count.

The page data in the hot block may be estimated to be page data having a high probability of page copying after data compaction based on past access frequency. On the other hand, the page data in the cold block may be estimated to be page data having a low probability of page copying after data compaction based on past access frequency. Wear-leveling may be actively managed by assigning page data in hot blocks to memory blocks having a low erase count.

Nonvolatile memory device 122 performs read, write, and erase operations under control of storage controller 121. Nonvolatile memory device 122 is typically formed of a plurality of memory blocks each comprising a plurality of pages. In the event that the nonvolatile memories are connected via at least two channels, their performance may be improved by controlling nonvolatile memory device 122 according to a memory interleaving technique. In addition, one channel may be connected with a plurality of memory devices, connected to the same data bus.

Although some of the described embodiments relate to memory devices using NAND flash memory as a storage medium, the described memory devices can be formed of alternative types of nonvolatile memory devices. For example, they may use as a storage medium PRAM, MRAM, ReRAM, FRAM, NOR flash memory, or various other types of nonvolatile memory devices. Moreover, certain embodiments can be applied to memory systems using multiple different types of memory devices, such as volatile memory devices (e.g., DRAM) in combination with nonvolatile memory devices.

Storage device 120 assigns page data to different memory blocks according to their update frequency. As described above, the update frequency of page data can be estimated using an attribute of a memory block in which page data is stored. For example, it is possible to estimate an update frequency of page data based on whether the corresponding memory block is a hot block or a cold block. By using an estimate of page update frequency, data compaction can be performed with greater efficiency compared as compared with methods that detect an actual page update frequency of each page.

During data compaction, storage device 120 assigns page data stored in cold blocks to memory blocks having a relatively large erase count, and it assigns page data stored in hot blocks to memory blocks having a relatively small erase count. Page data stored in hot blocks generally have relatively high update frequency and page data stored in cold blocks generally have relatively low update frequency. With this setup, it is possible to improve the efficiency of wear-leveling by reducing an erase count difference of memory blocks in nonvolatile memory device 122. Accordingly, the life of storage device 100 may be prolonged.

In some embodiments, storage device 100 takes the form of a Solid State Drive (SSD). In such embodiments, storage controller 121 may be configured to communicate with host 110 using one of various interface protocols such as USB, MMC, PCI-E, SAS, SATA, PATA, SCSI, ESDI, or IDE.

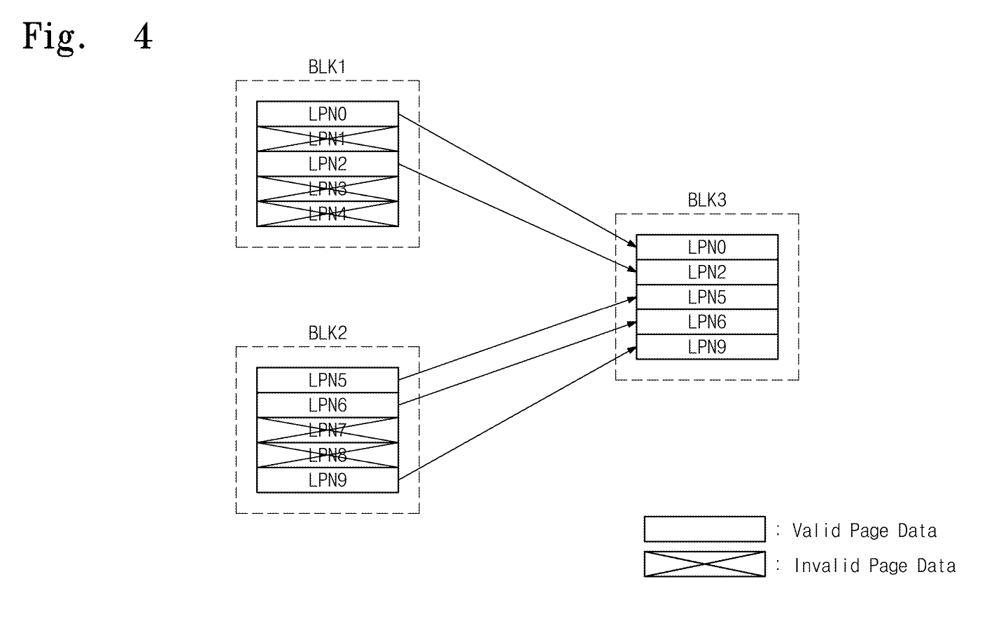

FIG. 3 is a block diagram illustrating an example of nonvolatile memory device 122 of FIG. 2 according to an embodiment of the inventive concept.

Referring to FIG. 3, nonvolatile memory device 122 comprises a cell array 210, an address decoder 220, a page buffer 230, and control logic 240.

Cell array 210 typically comprises a plurality of memory blocks; however, FIG. 3 shows only one memory block for ease of description. Each memory block comprises a plurality of pages each comprising a plurality of memory cells.

Nonvolatile memory device 122 performs erase operations on a memory block basis and performs read and write operations on a page basis. An update frequency of page data is estimated according to an attribute of a memory block in which the page data is stored.

Cell array 210 comprises a plurality of memory cells arranged in a plurality of cell strings. A cell string typically comprises a string selection transistor SST connected with a string selection line SSL, a plurality of memory cells connected with a plurality of word lines WL0 through WLn-1, respectively, and a ground selection transistor GST connected with a ground selection line GSL. String selection transistor SST is connected to a corresponding bit line BL, and ground selection transistor GST is connected to a common source line CSL.

Memory cells of cell array 210 can be implemented with a charge storage layer such as a floating gate or a charge trap layer or a memory cell having a resistance-variable element, for example. Cell array 210 can be implemented with a single-layer array structure (referred to as a two-dimensional array structure) or a multi-layer array structure (referred to a vertical or stack three-dimensional array structure).

Address decoder 220 is connected to cell array 210 via selection lines SSL and GSL and word lines WL0 through WLn-1. In a program or read operation, address decoder 220 selects a word line (e.g., WL1) based on an address. Address decoder 220 supplies voltages for a program or read operation to selected and unselected word lines.

Page buffer 230 acts as a write driver or a sense amplifier. Page buffer 230 buffers data to be programmed in selected memory cells or data read therefrom. Page buffer 230 is connected to cell array 210 via bit lines BL0 through BLm-1. In a program operation, page buffer 230 stores input data in memory cells of a selected page. In a read operation, page buffer 230 reads data from memory cells of a selected page.

Control logic 240 controls programming, reading, and erasing of nonvolatile memory device 122 according to a command from an external source or under control of an external device. For example, in a program operation, control logic 240 controls address decoder 220 such that a program voltage is supplied to a selected word line. Control logic 240 controls page buffer 230 such that program data is provided to a selected page.

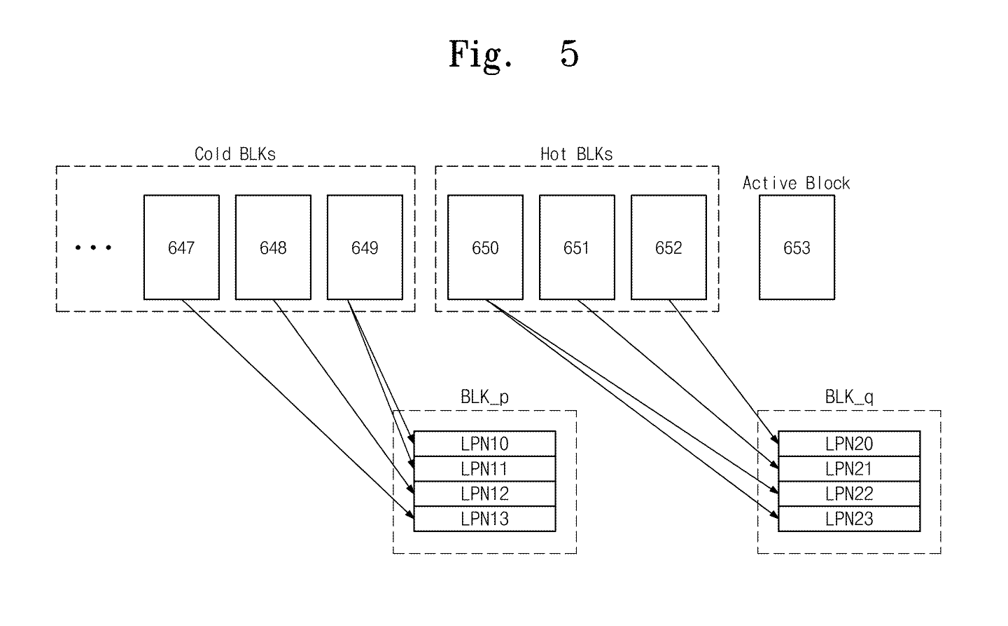

FIG. 4 is a diagram for describing a data compaction operation according to an embodiment of the inventive concept.

Referring to FIG. 4, a nonvolatile memory device comprises a first memory block BLK1, a second memory block BLK2, and a third memory block BLK3.

First memory block BLK1 comprises five pages of data LPN0 through LPN4. Second memory block BLK2 comprises five pages of data LPN5 through LPN9. Pages LPN0, LPN2, LPN5, LPN6, and LPN 9 in first and second memory blocks BLK1 and BLK2 are valid page data, as indicated by the absence of “x” marks. The remaining pages are invalid, as indicated by “x” marks.

In the data compaction operation, valid pages of data in two or more origin blocks are gathered in a destination block, and the two or more origin blocks may be erased. In the example of FIG. 4, first and second blocks BLK1 and BLK2 are origin blocks and third block BLK3 is a destination block. Valid pages of data in first and second memory blocks BLK1 and BLK2 are transferred to third memory block BLK3 and first and second memory blocks BLK1 and BLK2 are erased. The erased memory blocks can then be assigned to record new data.

The data compaction operation can be used to improve the efficiency of memory usage. For example, because a flash memory performs an erase operation on a block basis and does not support overwriting, the data compaction operation may be used to prevent unnecessary consumption.

The operation shown in FIG. 4 represents one type of data compaction operation. However, other types of data compaction operations can be performed in various alternative embodiments. Examples of other types of data compaction operations include, e.g., merge operations and garbage collection.

FIG. 5 is a diagram for describing a data management method according to an embodiment of the inventive concept.

Referring to FIG. 5, a nonvolatile memory device comprises six queuing blocks 647, 648, 649, 650, 651, and 652 to be assigned for data writing and two memory blocks BLK_p and BLK_q for data compaction. An erase count of memory block BLK_p is larger than that of memory block BLK_q. The method performs data compaction according to attributes of the queuing blocks, such as whether they are hot or cold blocks.

An active block 653 is a block in which write data is to be written in a current program operation. Reference numerals of the queuing blocks indicate their respective allocation orders. For example, an allocation order of queuing block 651 is 651. An allocation order having a larger number is assigned to a more recently assigned queuing block. An allocation order having a smaller number is assigned to an early assigned queuing block. An allocation order of active block 653 is 653.

Block assignment for data writing is made according to a time sequence. For example, a queuing block having high allocation order is a recently assigned block. The probability that page data having a large update frequency was recently updated may be high. Accordingly, the probability that page data having a large update frequency is included in a recently assigned block (i.e., a block having a large number corresponding to an allocation order) may be high. On the other hand, the probability that page data having a low update frequency is included in a recently assigned block is relatively low. An attribute of a queuing block can be determined as follows based this assumption. For example, page data with a high update frequency is assumed to be stored in queuing blocks having high allocation orders. Such blocks are considered to be hot blocks. Similarly, page data with a low update frequency is assumed to be stored in queuing blocks having low allocation orders. Such blocks are considered to be cold blocks.

A relative magnitude of an allocation order (i.e., whether an allocation order is high or low) may be determined by comparison with a reference value. For example, if an allocation order of a block is greater than or equal to the reference value, the block may be determined to be a hot block. If an allocation order of a block is less than the reference value, the block may be determined to be a cold block.

In the example of FIG. 5, It is assumed that the reference value is 649.5. Accordingly, queuing blocks 650, 651, and 652 (their allocation orders larger than the reference value 649.5) are deemed to be hot blocks, and queuing blocks 647, 648, and 649 (their allocation orders smaller than the reference value 649.5) are deemed to be cold blocks.

Valid pages of data LPN20, LPN21, LPN22, and LPN23 in hot blocks 650, 651, and 652 are estimated to be pages with high update frequency, so they are assigned to memory block BLK_q having a small erase count to manage wear-leveling. On the other hand, valid pages of data LPN10, LPN11, LPN12, and LPN13 in cold blocks 647, 648, and 649 are estimated to have low update frequency, so they are assigned to memory block BLK_p having a large erase count to manage wear-leveling.

In some embodiments, the reference value is determined by subtracting a specific value (e.g., 5.5) from an allocation order of the active block (e.g., active block 653). The specific value (e.g., 5.5) can be changed as occasion demands. Accordingly, the probability that a queuing block having a low allocation order becomes a hot block may be low. Thus, because an allocation order of a block assigned prior to active block 653 is lowered, the probability that a block assigned prior to active block 653 becomes a hot block may be low. In alternative embodiments, a developer can use various other techniques to determine an optimized fixed or variable value as the reference value. For instance, a value used to classify queuing blocks according to an allocation order can be used as the reference value.

In the method of FIG. 5, pages having a high update frequency are generally assigned to memory blocks having small erase counts, allowing relatively efficient wear-leveling. In certain embodiments, an update frequency of each page of data is judged by a block unit. That is, valid pages of data in a hot block are estimated to be pages of data having high update frequency. Thus, as compared with a method that detects an update frequency for every page data, a cost may be reduced and speed may increase. Moreover, the use of an allocation order to categorize memory blocks reduces the amount of metadata required to perform wear leveling. Accordingly, a necessary memory volume may be reduced as compared with methods where an update frequency is detected for every page data. Because an update frequency is judged by an allocation order of each block, data compaction operations may be reduced.

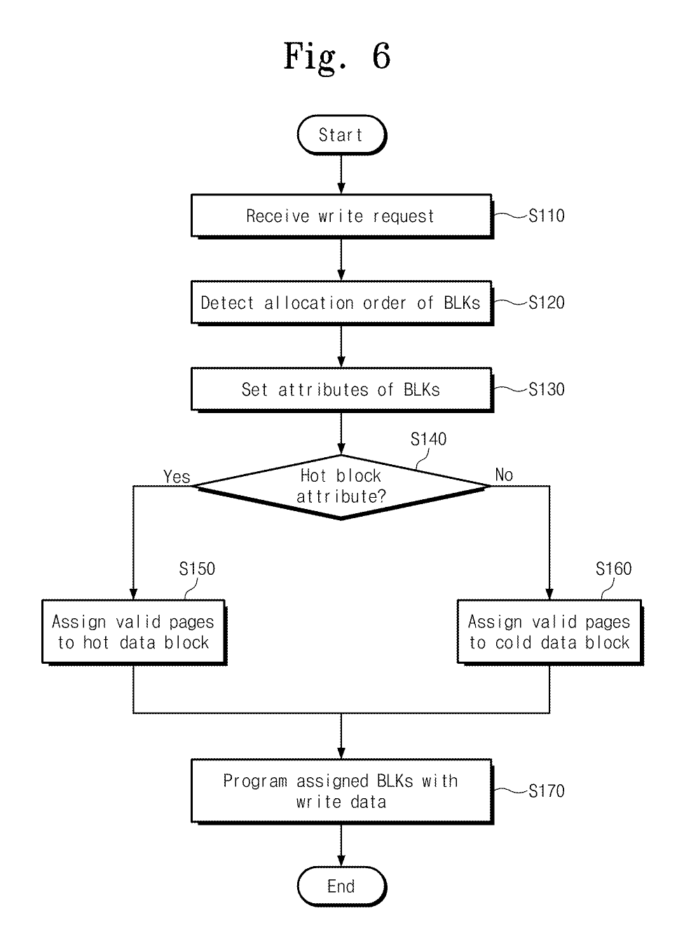

FIG. 6 is a flowchart illustrating a data management method according to an embodiment of the inventive concept.

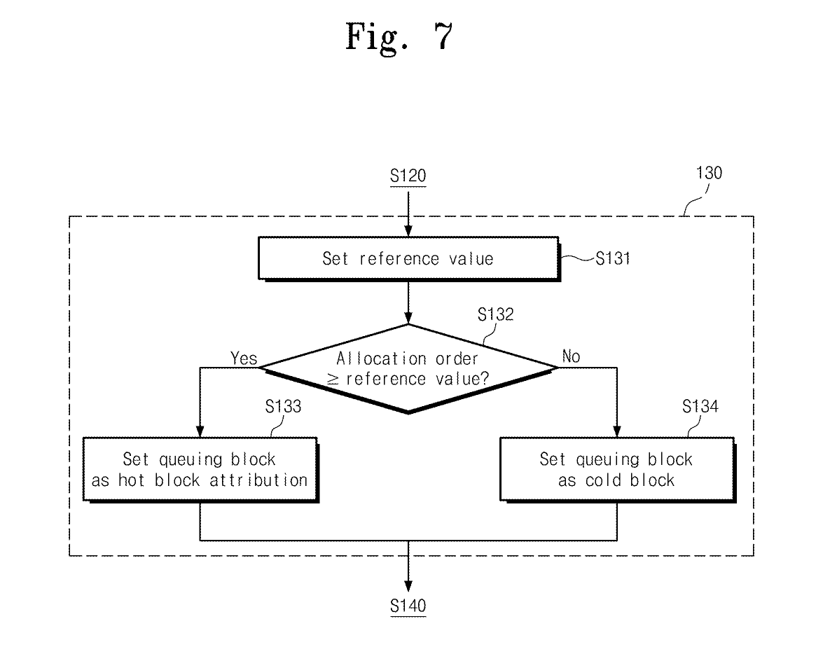

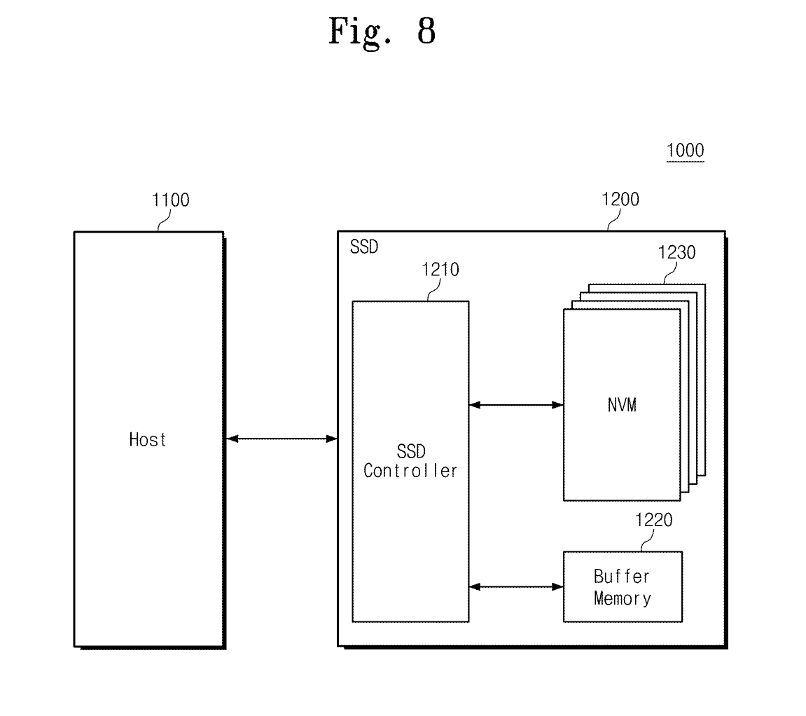

Referring to FIG. 6, a data management method comprises operations S110 through S170. In operation S110, a data storage device receives a write request. Upon receiving the write request, the data storage device allocates queuing blocks for write data. In operation 5120, an allocation order of each queuing block is detected. At this time, a recently assigning queuing block has a relatively high allocation order. In operation S130, attributes of the queuing blocks are set. For example, a queuing block can be designated as a hot block or a cold block. The hot block may be a block having relatively high update frequency, and the cold block may be a block having relatively low update frequency. A method of determining a block attribute will be more fully described with reference to FIG. 7.

In operation S140, the method determines whether an attribute of a queuing block is set to a hot block. If the queuing block is a hot block (S140=Yes), the method proceeds to operation S150. If the queuing block is not a hot block (i.e., it is cold block) (S140=No), the method proceeds to operation S160.

In operation S150, valid pages of the block are assigned to a block (hereinafter, referred to as a hot data block) having a low erase count. After the valid pages are recorded in the hot data block, the queuing block is erased so it can be programmed with write data.

In operation S160, valid pages of the queuing block are assigned to a block (hereinafter, referred to as a cold data block) having a high erase count. After valid pages are recorded in the cold data block, the queuing block is erased so it can be programmed with write data.

FIG. 7 is a flowchart for describing an example of operation S130 of FIG. 6.

Referring to FIG. 7, operation S130 comprises operations S131 through S134. In operation S131, a reference value for judging an attribute of a queuing block is set. The reference value can be determined according to various alternative techniques. For example, a developer can determine an optimized fixed or variable value as the reference value, or a value used to classify queuing blocks according to an allocation order can be used as the reference value.

In some embodiments, the reference value is determined as follows. A value obtained by subtracting a specific value (e.g., 5.5) from an allocation order of an active block 653 may be used as the reference value. The specific value (e.g., 5.5) can be changed as occasion demands. Accordingly, the probability that a queuing block having a low allocation order becomes a hot block may be low. Thus, as an allocation order of a block assigned prior to active block 653 is lowered, the probability that a block assigned prior to active block 653 becomes a hot block may be low.

In operation S132, the allocation order of the queuing block is compared with the reference value. If the allocation order of the queuing block is greater than or equal to the reference value (S132=Yes), the method proceeds to operation S133. If the allocation order of the queuing block is less than the reference value (S132=No), the method proceeds to operation S134. In operation S133, a corresponding queuing block is set to have a hot block attribute, and the method proceeds to operation S140 of FIG. 6. In operation S134, a corresponding queuing block is set to have a cold block attribute, and the method proceeds to operation S140 of FIG. 6.

In the above description memory blocks are categorized as hot blocks and cold blocks. However, the inventive concept is not limited to these attribute values. For example, an attribute of a memory block can have three or more levels according to an allocation order of a memory block.

FIG. 8 is a block diagram illustrating an electronic device 1000 comprising a solid state disk according to an embodiment of the inventive concept.

Referring to FIG. 8, electronic device 1000 comprises a host 1100 and an SSD 1200. SSD 1200 comprises an SSD controller 1210, a buffer memory 1220, and a nonvolatile memory device 1230.

SSD controller 1210 provides a physical interconnection between host 1100 and SSD 1200. SSD controller 1210 provides an interface with SSD 1200 according to a bus format of host 1100. SSD controller 1210 decodes a command provided from host 1100, and SSD controller 1210 accesses nonvolatile memory device 1230 according to a result of the decoding. Host 1100 typically uses a standard bus format such as, e.g., Universal Serial Bus (USB), Small Computer System Interface (SCSI), Peripheral Component Interconnect (PCI) express, Advanced Technology Attachment (ATA), Parallel ATA (PATA), Serial ATA (SATA), or Serial Attached SCSI (SAS).

SSD controller 1210 detects an allocation order of an active memory block to be written with write data from host 1100. An attribute of the memory block is set to a hot block or a cold block based on a comparison between its program and/or erase cycles and a reference value. The reference value may be determined according to the allocation order of the active memory block.

In some embodiments, the reference value is obtained by subtracting a specific value from an allocation order of the active memory block. For example, where an allocation order of the active memory block is 100 and the specific value is 5, the reference value may be set to 95. As an assigned location becomes farther from the active memory block, the allocation order of the memory block is reduced, and the probability that the memory block is a cold block increases.

In response to a write request, SSD controller 1210 assigns a write-requested page to a memory block having a relatively large or small erase count based on an attribute of the memory block. Because pages in a hot block are updated with relatively high frequency, these pages may be assigned to a block having a low erase count. On the other hand, because pages in a cold block are updated with relatively low frequency, these pages may be assigned to a block having a large erase count. In this case, a difference between erase counts of memory blocks may be reduced in order to improve a management efficiency of wear-leveling of a memory device.

Buffer memory 1220 temporarily stores write data provided from host 1100 or data read out from nonvolatile memory device 1230. In the event that data in nonvolatile memory device 1230 is cached at a read request of host 1100, buffer memory 1220 may support a cache function of providing cached data directly to host 1100. Typically, a data transfer speed of a bus format (e.g., SATA or SAS) of host 1100 is higher than that of a memory channel of SSD 1200. In the event that an interface speed of host 1100 is remarkably fast, lowering of the performance due to a speed difference may be minimized by providing buffer memory 1220 having a large storage capacity.

Buffer memory 1220 can be formed of a synchronous DRAM to provide sufficient buffering to SSD 1200 used as an auxiliary mass storage device. However, buffer memory 1220 is not limited to this form.

Nonvolatile memory device 1230 is provided as a storage medium of SSD 1200. Nonvolatile memory device 1230 typically comprises a NAND flash memory device, and it can be formed of multiple memory devices connected with SSD controller 1210 in channel units. Nevertheless, nonvolatile memory device 1230 is not limited to a NAND flash memory device and can take other forms, such as a PRAM, an MRAM, a ReRAM, a FRAM, or a NOR flash memory, for instance. Further, certain embodiments of the inventive concept may be applied to a memory system which uses different types of memory devices together. A volatile memory device (e.g., DRAM) can be used as the storage medium.

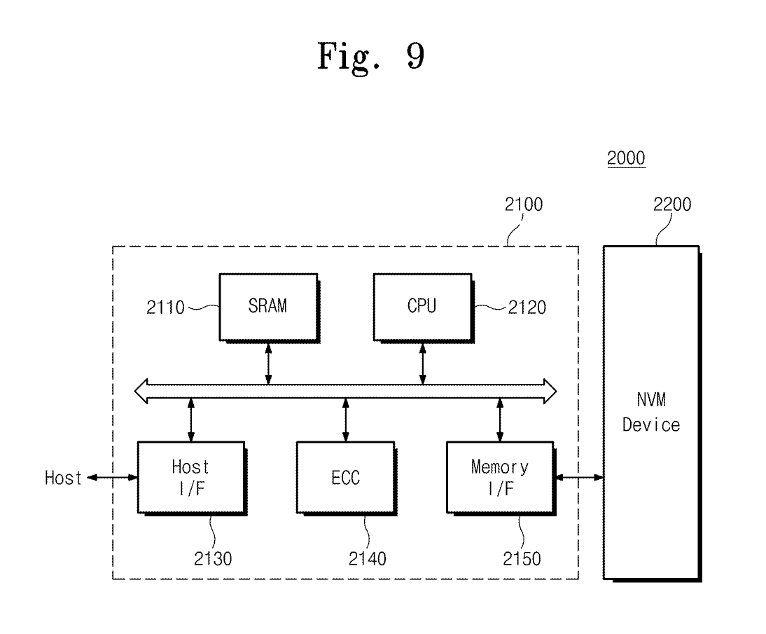

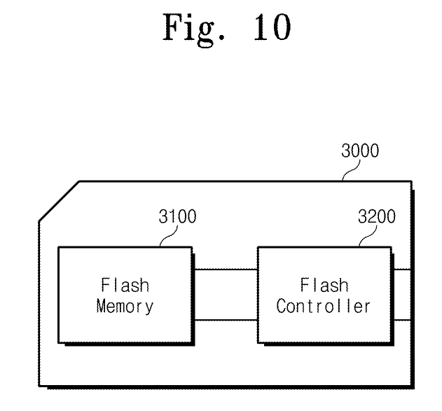

FIG. 9 is a block diagram illustrating a memory system 2000 according to an embodiment of the inventive concept.

Referring to FIG. 9, memory system 2000 comprises a memory controller 2100 and a nonvolatile memory device 2200.

Memory controller 2100 is configured to control nonvolatile memory device 2200. Collectively, nonvolatile memory device 2200 and memory controller 2100 form constitute a memory card. Within nonvolatile memory device 2200, an SRAM 2110 is used as a working memory. Herein, SRAM 2110 comprises a lookup table for storing an update number associated with each page of data. A host interface 2130 implements a data exchange protocol of a host connected with data storage device 2000. An ECC circuit 2140 is configured to detect and correct an error of data read out from nonvolatile memory device 2200. A memory interface 2150 is configured to interface with nonvolatile memory device 2200. As a processing unit, a CPU 2120 is configured to perform control operations for exchanging data with nonvolatile memory device 2200. Although not shown, data storage device 2000 may further comprise a ROM that stores code data for interfacing with a host.

In response to a write request, memory controller 2100 allocates a write-requested page to a memory block having a relatively large or small erase count based on an attribute of a memory block. Because the frequent update probability of pages in a hot block is high, the pages may be allocated to a block having a low erase count. On the other hand, because the frequent update probability of pages in a hot block is low, the pages may be allocated to a block having a large erase count. In this case, a difference between erase counts of memory blocks may be reduced to improve management efficiency of wear-leveling of a memory device.

Nonvolatile memory device 2200 can be implemented by a multi-chip package formed of a plurality of flash memory chips. Memory system 2000 can be provided as a high-reliability storage medium with the low error probability. Memory controller 2100 may be configured to communicate with an external device (e.g., a host) via one of various interface protocols such as USB, MMC, PCI-E, SAS, SATA, PATA, SCSI, ESDI, or IDE, for example.

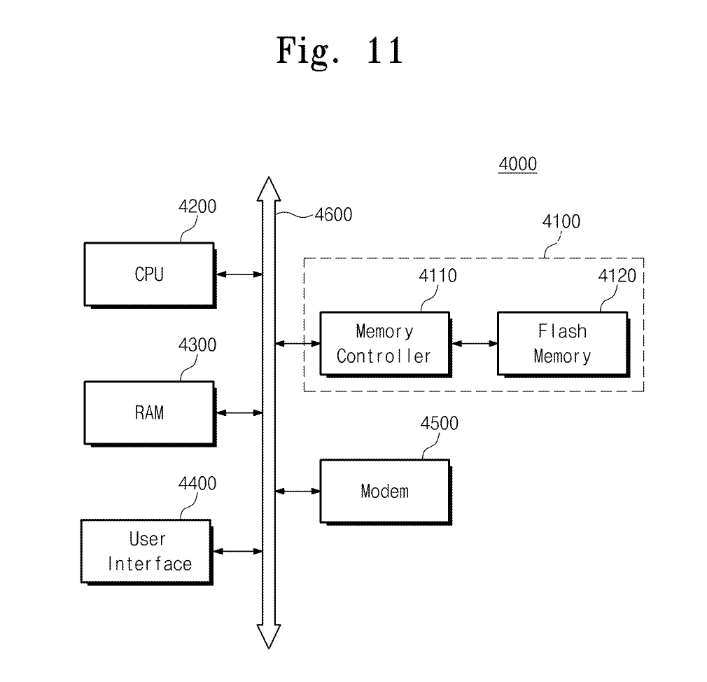

FIG. 10 is a block diagram illustrating a data storage device 3000 according to an embodiment of the inventive concept.

Referring to FIG. 10, data storage device 3000 comprises a flash memory 3100 and a flash controller 3200. Flash controller 3200 controls flash memory 3100 in response to control signals received from the outside of data storage device 3000.

In response to a write request, flash controller 3200 assigns a write-requested page to a memory block having a relatively large or small erase count based on an attribute of a memory block. Because the frequent update probability of pages in a hot block is high, the pages may be allocated to a block having a low erase count. On the other hand, because the frequent update probability of pages in a hot block is low, the pages may be allocated to a block having a large erase count. In this case, a difference between erase counts of memory blocks may be reduced in order to improve a management efficiency of wear-leveling of a memory device.

Data storage device 3000 can be, for example, a memory card device, an SSD device, a multimedia card device, an SD device, a memory stick device, a HDD device, a hybrid drive device, or a USB flash device. Moreover, data storage device 3000 may be a card satisfying an industrial standard for an electronic device, such as a digital camera or a personal computer.

FIG. 11 is a diagram illustrating a computing system 4000 comprising a flash memory device according to an embodiment of the inventive concept.

Referring to FIG. 11, computing system 4000 comprises a memory system 4100, a CPU 4200, a RAM 4300, a user interface 4400, and a modem 4500 such as a baseband chipset which are electrically connected with a bus 4400. Memory system 4100 can be configured substantially identical to the SSD shown in FIG. 8, a memory system shown in FIG. 9, or a memory card shown in FIG. 10.

Where computing system 4000 is a mobile device, it may further comprise a battery (not shown) for providing power during mobile operation. Although not shown, computing system 4000 may further comprise additional features such as an application chipset, a camera image processor (CIS), a mobile DRAM, and others. Memory system 4100 may comprise an SSD, for example. Alternatively, memory system 4100 may be implemented by a fusion memory (e.g., a One-NAND flash memory).

Where a write request is issued from CPU 4200, memory controller 4110 allocates a write-requested page to a memory block having a relatively large or small erase count based on an attribute of a memory block. Because the frequent update probability of pages in a hot block is high, the pages may be allocated to a block having a low erase count. On the other hand, because the frequent update probability of pages in a hot block is low, the pages may be allocated to a block having a large erase count. In this case, a difference between erase counts of memory blocks may be reduced, so that a management efficiency of wear-leveling of a memory device may be improved.

A nonvolatile memory device and/or a memory controller as described above may be packaged in various types of packages or package configurations such as Package on Package (PoP), Ball grid arrays (BGAs), Chip scale packages (CSPs), Plastic Leaded Chip Carrier (PLCC), Plastic Dual In-Line Package (PDI2P), Die in Waffle Pack, Die in Wafer Form, Chip On Board (COB), Ceramic Dual In-Line Package (CERDIP), Plastic Metric Quad Flat Pack (MQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), or Wafer-Level Processed Stack Package (WSP).

As indicated by the foregoing, various embodiments of the inventive concept allow wear-leveling to be efficiently managed by allocating page data having a high update frequency to a block having a low erase count. The efficiency of data compaction may be improved because an update frequency of page data is determined by block unit. Further, it is possible to efficiently manage data since an update count of page data is not managed. The foregoing is illustrative of embodiments and is not to be construed as limiting thereof. Although a few embodiments have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims.

What is claimed is:

1. A method of operating a storage device comprising a nonvolatile memory device, the method comprising:
detecting an allocation order of a first memory block storing page data; and
assigning page data in the first memory block to a second memory block having a first erase count or a third memory block having a second erase count larger than the second erase count, based on the detected allocation order.

2. The method of claim 1, further comprising assigning the page data to the second memory block upon determining that the allocation order of the first memory block is larger than a reference value.

3. The method of claim 2, further comprising assigning the page data to the third memory block upon determining that the allocation order of the first memory block is smaller than the reference value.

4. The method of claim 3, further comprising determining the reference value based on an allocation order of a fourth memory block in which write data is to be stored.

5. The method of claim 4, further comprising adjusting the allocation order according to allocation of additional memory blocks.

6. The method of claim 5, further comprising storing an allocation order of the first or fourth memory block in a working memory.

7. The method of claim 6, wherein the working memory is a static random access memory (SRAM).

8. The method of claim 1, further comprising storing the page data in the assigned second or third memory block.

9. The method of claim 1, wherein the page data is transferred from the first memory block to the second or third memory block in a data compaction operation.

10. The method of claim 9, further comprising erasing the first memory block following the data compaction operation.

11. A data storage device, comprising:
a nonvolatile memory device; and
a memory controller configured to assign page data in a first memory block to a second memory block or a third memory block having an erase count larger than the second memory block, based on an allocation order of the first memory block assigned to write data.

12. The data storage device of claim 11, wherein if the allocation order of the first memory block is larger than a reference value, the page data is assigned to the second memory block.

13. The data storage device of claim 12, wherein if the allocation order of the first memory block is smaller than the reference value, the page data is assigned to the third memory block.

14. The data storage device of claim 13, wherein the reference value is determined based on an allocation order of a fourth memory block in which write data is stored.

15. The data storage device of claim 14, wherein the allocation order of the first memory block varies according to when it was assigned.

16. The data storage device of claim 11, wherein the memory controller comprises a flash translation layer configured to convert a logical address from an external device into a physical address of the nonvolatile memory device in response to a data write request.

17. The data storage device of claim 16, wherein the flash translation layer converts the logical address into the physical address according to a page address mapping technique.

18. The data storage device of claim 11, wherein the nonvolatile memory device and the memory controller constitute a solid state drive.

19. A method of managing data in a nonvolatile memory device, comprising:
determining an allocation order of a first memory block;
comparing the allocation order to a reference value; and
assigning valid data of the first memory block to a hot block or a cold block according to a result of the comparison.

20. The method of claim 19, further comprising assigning the valid data of the first memory block to the hot block and transferring the assigned valid data to the hot block upon determining that the allocation order is less than the reference value.
